(19) United States
(12) Patent Application Publication
(10) Pub. No.: US 2022/0348048 A1
(43) Pub. Date: Nov. 3, 2022

(54) Tow Bar for Scooter

(71) Applicant: Jocelyn Bruno, Cibolo, TX (US)

(72) Inventor: Jocelyn Bruno, Cibolo, TX (US)

(21) Appl. No.: 17/866,863

(22) Filed: Jul. 18, 2022

Related U.S. Application Data
(63) Continuation-in-part of application No. 17/065,314, filed on Oct. 7, 2020, now Pat. No. 11,383,565.

(51) Int. Cl. B60D 1/155; B60D 1/52; B60D 1/54

(52) U.S. Cl. CPC B60D 1/155; B60D 1/52; B60D 1/54; B60D 2001/005

(57) ABSTRACT

A tow bar for connecting a motorized utility cart to a shopping cart includes a second tow bar segment pivotally attached to the first tow bar segment at a first hinge that defines a first axis; a third segment pivotally attached to the second tow bar segment at a second hinge that defines a second axis parallel to the first axis; an accessory connection attached to the first tow bar segment, the accessory connection provides for attachment to the motorized utility cart; a clamp attached to the third segment, the clamp for attachment to the shopping cart; and a ball joint that permits the clamp to articulate with respect to the second hinge.

The present disclosure is a continuation-in-part of U.S. patent application Ser. No. 17/065,314, filed Oct. 7, 2020, whose disclosure is hereby incorporated by reference in its entirety into the present disclosure.

### BACKGROUND

The present disclosure relates to a tow bar for towing a shopping cart with a motorized utility cart or scooter.

There is a rapidly growing market for personal or one person motorized utility carts or scooters. Most frequently such scooters have been used by people who have been permanently or temporarily incapacitated. Since such carts are designed for inside use, they are of a width which enables them to pass easily through normal door openings. Thus, they can easily be used for navigating through stores and shopping malls.

A problem which occurs while shopping is the lack of cargo space on the scooter. Numerous attempts to provide for cargo space on scooters have been made, the attempts typically involve positioning a basket on the scooter, the basket providing very limited cargo space.

### SUMMARY

A tow bar for connecting a motorized utility cart to a shopping cart according to one disclosed non-limiting embodiment of the present disclosure includes a second tow bar segment pivotally attached to the first tow bar segment at a first hinge that defines a first axis; a third segment pivotally attached to the second tow bar segment at a second hinge that defines a second axis parallel to the first axis; an accessory connection attached to the first tow bar segment, the accessory connection provides for attachment to the motorized utility cart; a clamp attached to the third segment, the clamp for attachment to the shopping cart; and a ball joint that permits the clamp to articulate with respect to the second hinge.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a perspective view of a tow bar that attaches a motorized utility cart to a shopping cart according to one disclosed non-limiting embodiment.

FIG. 2 is a top view of the tow bar.

FIG. 3 is an expanded side view of the tow bar.

FIG. 4 is a perspective view of an attachment to the shopping cart.

FIG. 5 is a side view of the attachment to the shopping cart.

### DETAILED DESCRIPTION

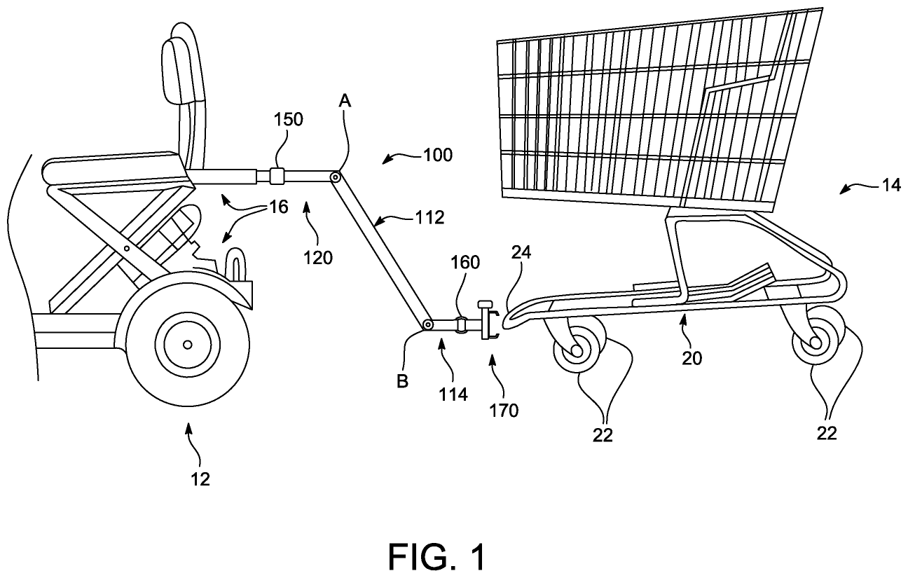

FIG. 1 schematically illustrates a tow bar 100 that can be used to connect a motorized utility cart or scooter 12 to a shopping cart 14. The scooter 12 generally includes a chassis, to which a motor, battery, seat, steering system, suspension system, etc., are mounted. The scooter 12 typically includes an accessory mount 16. For example, the Golden Technology mobility scooter model G L-111 has a tubular mounting bracket as the accessory mount typical of a trailer hitch.

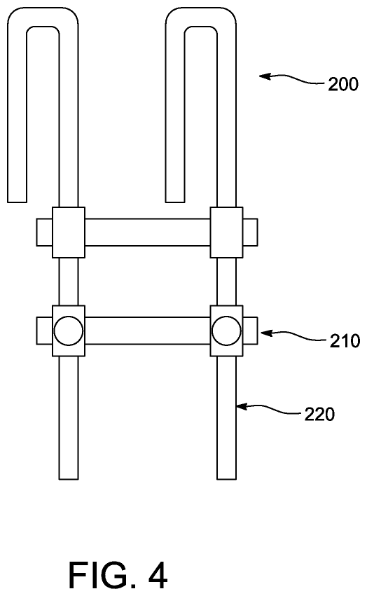

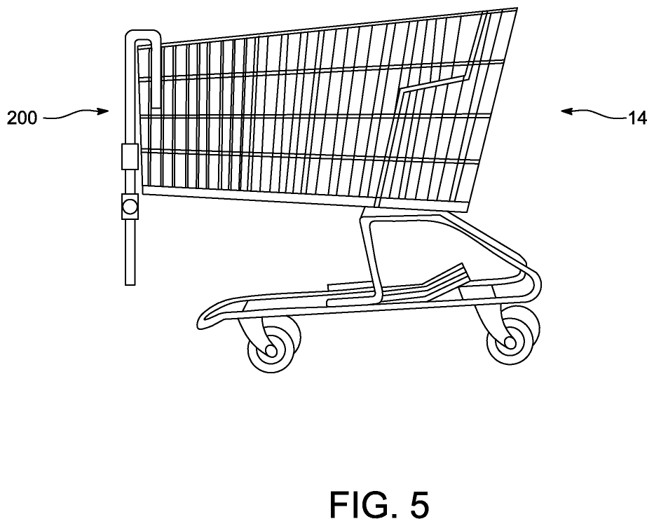

The shopping cart 14 generally includes a frame 20 supported on wheels 22. The frame 20 includes a lower shelf that includes a horizontal forward member 24. Essentially all shopping carts have these general features. The horizontal forward member 24, being elongated and running transverse to the direction of travel of the cart 14 is the designated attachment point for the tow bar 100. Alternatively, the tow bar 100 may be attached to a framing member 200 (FIG. 4) that is hung onto the cart 14 (FIG. 5). A sliding component 210 may be mounted to hanging bars 220 to provide for an adjustable attachment for the tow bar 100

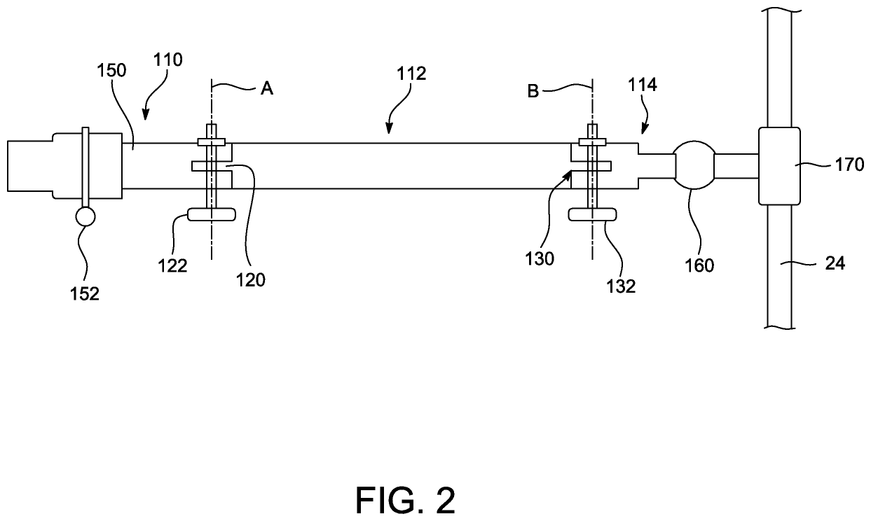

The tow bar 100 generally includes a first tow bar segment 110, a second tow bar segment 112 and a third tow bar segment 114. The first tow bar segment 110 is pivotally attached to the second tow bar segment 112 at hinge 120 that hinges about an axis A (also shown in FIG. 2). The second tow bar segment 112 is pivotally attached to the third tow bar segment 114 at a hinge 130 that hinges about an axis B (also shown in FIG. 2). Axis A and axis B are parallel and also typically parallel to the horizontal forward member 24. The tow bar segments may be square in cross section.

The hinges 120, 130 may freely hinge about their respective axes, or in the alternative, may include locking pins 122, 132 that permit the hinges, 120, 130 to be locked at a desired angle. That is, the locking pins 122, 132 may be, for example, pressed to overcome a spring force then released when the segments are at a desired angle thereby fixing the angle of the relative segments. Alternatively, the locking pins 122, 132 may be threaded fasteners with handles that permit the selective hinging or locking of the respective segments. The angles of the tow bar 100 may be adjusted to allow for smooth articulated towing of the shopping cart 14.

The first tow bar segment 110 includes an accessory connection 150 that mounts to the accessory mount 16. The accessory connection 150 may be attached to the accessory mount in a telescoping interface and retained via a pin 152 or other fastener.

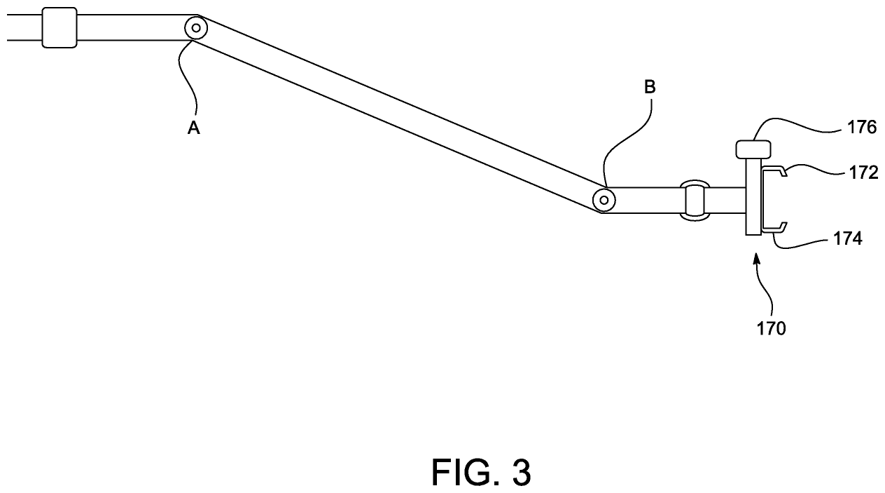

The third tow bar segment 114 includes a ball joint 160 and a clamp 170. The ball joint 160 permits the clamp 170 to articulate with respect to the hinge 130. The clamp 170 in one embodiment, can be configured, for example, as a threaded clamp with jaws 172, 174 (FIG. 3) that are tightened and loosened by a threaded handle 176 for attachment to the horizontal forward member 24. The clamp 170 in another embodiment can be configured, for example, as a spring loaded grasping hook or other member attachable to the horizontal forward member 24

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A tow bar for connecting a motorized utility cart to a shopping cart, comprising:
a first tow bar segment;
a second tow bar segment pivotally attached to the first tow bar segment at a first hinge that defines a first axis;
a third segment pivotally attached to the second tow bar segment at a second hinge that defines a second axis parallel to the first axis;
an accessory connection attached to the first tow bar segment, the accessory connection provides for attachment to the motorized utility cart;
a clamp attached to the third segment, the clamp for attachment to the shopping cart; and
a ball joint that permits the clamp to articulate with respect to the second hinge.

2. The tow bar as recited in claim 1, wherein the first hinge and the second hinge are lockable.

3. The tow bar as recited in claim 1, wherein the clamp is spring loaded.

4. The tow bar as recited in claim 1, wherein the clamp comprises a threaded clamp with jaws.

5. The tow bar as recited in claim 1, wherein the tow bar segments are square in cross section.

6. The tow bar as recited in claim 1, wherein the first hinge and the second hinge are lockable may freely hinge about their respective axes.
